(19) United States
(12) Patent Application Publication
(10) Pub. No.: US 2006/0286022 A1
(43) Pub. Date: Dec. 21, 2006

(54) Nanosized carbonaceous material three-dimensional structure and process for producing the same

(76) Inventors: Yoshiyuki Miyamoto, Tokyo (JP); Takazumi Kawai, Tokyo (JP)

Correspondence Address: HAYES, SOLOWAY P.C., 3450 E. SUNRISE DRIVE, SUITE 140, TUCSON, AZ, 85718, US

(21) Appl. No.: 10/558,333

(22) PCT Filed: May 20, 2004
(86) PCT No.: PCT/JP04/06820

§ 371 Date: Nov. 23, 2005

(30) Foreign Application Priority Data
May 23, 2003 (JP) 2003-146569

(51) Int. Cl. C01B 31/02

(52) U.S. Cl. 423/445 R; 428/408

(57) ABSTRACT

According to the present invention, there are provided a novel graphite-like three-dimensional structure which has a partial structure bent-up with such a steeper curvature than that observed for a carbonaceous material having a conventional nanosize three-dimensional structure such as fullerene and nanotube, has such a feature as light weight and high mechanical strength, as well as a process for manufacturing the same. In the present invention, under a high temperature and a low pressure, a plurality of nanosize graphite layer fragments are forced to coming into collision at a high speed in a relative orientation where the layer planes are not set in parallel to form a carbonaceous three-dimensional structure where at least a plurality of graphite-layer-like layer planes having a hexagonal network structure made up of carbon are arranged such that they mutually cross or are in contact with each other and at the sites for the contact between the plurality of layer planes, connections via carbon-carbon covalent bonds are aligned in the shape of a cross-line.

### TECHNICAL FIELD

The present invention relates to a carbonaceous material three-dimensional structure having a nanosized three-dimensional structure and a producing process therefor. In particular, it relates to a carbonaceous material three-dimensional structure where said nanosized three-dimensional structure is a three-dimensional structure constructed by combining a plurality of graphite-layer-like layered parts having a hexagonal network structure made up of carbon as well as a process for forming the three-dimensional structure.

### BACKGROUND ART

There have been recently reported, in addition to a fine three-dimensional structure made up of single-layer wall such as single-layer carbon nanotube, a graphite-layer like multi-layered substance composed of a plurality of graphite-layer-like structures, as for a carbonaceous material having a fine structure in nanoscale. For instance, known examples of such a structure include a three-dimensional structure where multiple fine graphite layers are stacked up in a direction of a graphite c-axis; a multi-layer carbon nanotube or onion structure where multiple graphite layers are lapped over in the form of curved surface. A gas-absorbing surface structure in charcoal is also microscopically a type of fine structure where a plurality of graphite layers is piled up.

For example, in a nanosize carbonaceous material three-dimensional structure composed of curved graphite layers, the curved surface of the graphite layer functions as a site for adsorbing molecules or atoms and has a higher ratio of surface area per a unit volume. Therefore, there is increased progress for its use as a physical adsorbent for gaseous molecules or atoms.

### DISCLOSURE OF INVENTION

In terms of a fine three-dimensional structure made of a carbonaceous material, there has been looked forward to proposal of a novel carbonaceous material three-dimensional structure showing having such a nanosize steric structure that it shows structural form other than a fine three-dimensional structure made up of single-layer wall or a fine structure composed of stacked-up multiple graphite layers which has been previously reported, and it has a higher potential for light-weight and comparable or higher mechanical strength in comparison with a conventional carbonaceous material of multi-layered structure type. In particular, there has been needed to develop a new carbonaceous material three-dimensional structure having a structural form that is quite different from that of a conventional carbonaceous material having a nanosize fine three-dimensional structure, which can show stable functions under severe conditions (under a high temperature or a strain field) to be adapted to wide spectra of application such as a molecule/atom adsorbing structure, a material used in an electronic device or a material with persistence.

For solving the above problems, an objective of the present invention is to provide a carbonaceous material three-dimensional structure having a novel three-dimensional structure which can function stably under severe conditions (under a high temperature or a strain field) so as to be fit to a wide variety of applications such as a molecule/atom adsorbing structure, material for an electron device and material with persistence, as well as a process for the production thereof.

We made an extensive study with the view of solving the above problems, and we have obtained the following findings: For example, Laser evaporation of a material of graphite form such as graphite by means of laser abrasion method provides formation of a number of fine graphite pieces having a graphite-layer-like hexagonal network structure made up of carbon. When the resultant fine graphite pieces are condensated again, they are stacked up in layered form to reconstruct multi-layered graphite therefrom, and further, in such a case where a plurality of fine graphite pieces may occasionally come into contact with each other at inter-plane angle being non-parallel, a new carbon-carbon covalent bond is formed just at the site in contact, resulting in the production of a nanosize three-dimensional structure in which two or more graphite-layer-like hexagonal network structures made up of carbons are arranged at inter-plane angle being non-parallel to each other. In addition, in said nanosize three-dimensional structure where two or more graphite-layer-like hexagonal network structures made up of carbons are disposed at the inter-plane angle being non-parallel therebetween, a mutual arrangement of hexagonal network structures made up of graphite-layer-like carbon is determined by the carbon-carbon covalent bonds, is reliably maintained under severe conditions (for instance, under a high temperature and a strain field being initiated) and exhibits sufficiently high mechanical strength. Thus, based on those finding, we have completed the present invention.

That is to said, a carbonaceous three-dimensional structure that is provided according to an aspect of the present invention is

a carbonaceous three-dimensional structure which is a three-dimensional structure made of carbonaceous material comprising a plurality of graphite-layer-like layer planes that are composed of a hexagonal network structure made up of carbon, wherein

the plurality of graphite-layer-like layer planes are arranged such that they mutually intersect or are in contact with each other; and

at the sites for the contact between the plurality of layer planes, there are aligned connections via carbon-carbon covalent bonds in the shape of a cross-line. In such a case, it may be, for instance, a three-dimensional structure wherein the cross-line formed at the sites for the contact between the plurality of layer planes where there are aligned connections via carbon-carbon covalent bonds constructs a straight or curved line.

Further, preferred is the three-dimensional structure wherein as the sites for the contact between the plurality of layer planes where there are aligned connections via carbon-carbon covalent bonds, there is at least one structure where three or more surfaces of the graphite-layer-like layer planes are arranged so as to mutually intersect or are in contact with each other on the same cross-line.

Alternatively, a carbonaceous three-dimensional structure that is provided according to another aspect of the present invention is

a carbonaceous three-dimensional structure which is a three-dimensional structure made of carbonaceous material comprising a plurality of graphite-layer-like layer planes that are composed of a hexagonal network structure made up of carbon, wherein

the at least two graphite-layer-like layer planes are non-parallel graphite layer planes and have such a structure that the site for the contact therebetween forms a straight crease. In such a case, for example, it may be a tree-dimensional structure wherein among the plurality of graphite-layer-like layer planes including the at least two graphite-layer-like layer planes of which the site for the contact forms a straight crease, the at least two graphite-layer-like layer planes forming the straight crease and at least one additional graphite-layer-like layer plane have such a configuration as to mutually cross or be in contact with each other on the same cross-line.

Furthermore, in the carbonaceous three-dimensional structure according to the present invention, there may be provided

a carbonaceous three-dimensional structure which is a three-dimensional structure made of carbonaceous material comprising a plurality of graphite-layer-like layer planes that are composed of a hexagonal network structure made up of carbon, wherein

the structure comprises at least a frame composed of some of or all of the three-dimensional structures, which are given by the carbonaceous three-dimensional structures with the aforementioned constitutions of the present inventions, concurring in compositive manner.

In addition, a method for using a carbonaceous three-dimensional structure that is provided according to one aspect of the present invention is

a method of using any one of the carbonaceous three-dimensional structures with the aforementioned constitutions of the present inventions, wherein

the carbonaceous three-dimensional structure is used to form a molecule/atom adsorbing material.

Alternatively, a method for using a carbonaceous three-dimensional structure that is provided according to another aspect of the present invention is

a method of using any one of the carbonaceous three-dimensional structures with the aforementioned constitutions of the present inventions, wherein

the carbonaceous three-dimensional structure is used to form an electronic device having at least three terminals. In such a case, for example, the electronic device having at least three terminals may be a transistor.

Further, a method for using a carbonaceous three-dimensional structure that is provided according to another aspect of the present invention is

a method for using any one of the carbonaceous three-dimensional structures with the aforementioned constitutions of the present inventions, wherein

the carbonaceous three-dimensional structure is used to form a reinforcing material.

Besides, the present invention also provides a process for manufacturing the aforementioned carbonaceous three-dimensional structure of the present invention. That is, a process for manufacturing a carbonaceous material three-dimensional structure according to the present invention is

a process for constructing a carbonaceous three-dimensional structure, which process is process for constructing a three-dimensional structure made of carbonaceous material comprising a plurality of graphite-layer-like layer planes that are composed of a hexagonal network structure made up of carbon, wherein

said three-dimensional structure is any one of the carbonaceous three-dimensional structures having the aforementioned constitutions according to the present invention; and

the process comprises step of:

producing graphite-layer-like fragments having a hexagonal network structure made of carbon; and

forcing the graphite-layer-like fragments produced thereby into coming into collision with each other. In such a case, it is preferable that in the step of forcing the graphite-layer-like fragments,

at least two fragments are impacted to each other in an arrangement that the fragments mutually cross or are in contact with each other at an inter-plane angle between the graphite-layer-like fragments to be in collision showing substantially other than 180°.

### BRIEF DESCRIPTION OF THE DRAWINGS

FIG. 1 is an illustration schematically showing an example of a process for forming a three-dimensional structure of carbonaceous material according to the present invention.

FIG. 2 is a schematic view illustrating an example of an electronic device constructed by using a three-dimensional structure of carbonaceous material according to the present invention, explaining a three-terminal type electronic device configuration having such a set-up that three graphite layer planes contact on the same straight cross-line, in which configuration the cross-line portion acts as a potential barrier to a path between terminal 1 (the first terminal: source electrode terminal) and terminal 2 (the second terminal: drain electrode terminal) for current flowing across the cross-line portion, and a control voltage is applied to terminal 3 (the third terminal: gate) via a gate electrode (gate electrode unit) 4 to control the density of the current passing through the potential barrier in the cross-line.

FIG. 3 is a schematic view illustrating an example of a molecule/atom adsorbing material that is formed by using a three-dimensional structure of carbonaceous material according to the present invention, where three graphite layer planes contact on the same straight cross-line and whereby it fulfils a function of physically adsorbing molecules/atoms (adsorbed gas species 5) due to an adsorbing sites in the vicinity of the cross-line.

FIG. 4 is a schematic view showing an example of a reinforcing material that is formed by using a three-dimensional structure of carbonaceous material according to the present invention, where a plurality of partial structures, in which three graphite layer planes are in contact on the same straight cross-line, are joined up, and thereby as a whole, the structure is given with good performance for keeping mechanical strength resulting from the a honeycomb structure.

### BEST MODE FOR CARRYING OUT THE INVENTION

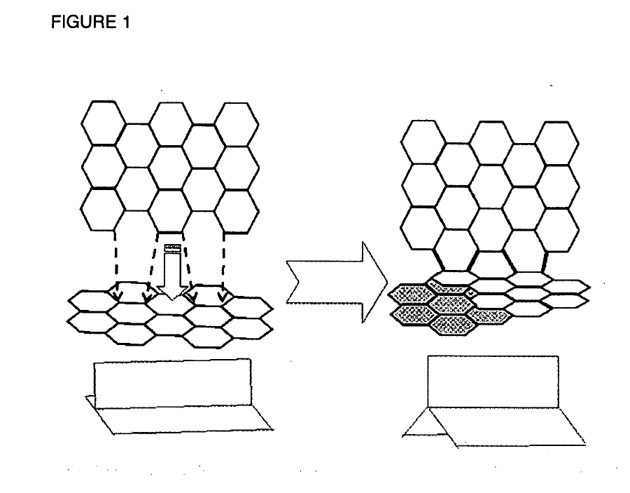

A carbonaceous three-dimensional structure according to the present invention has a three-dimensional structure where a wall plane having graphite layer type hexagonal network structure cross-links with another graphite-layer-like plane having hexagonal network structure from an off-plane direction to the wall plane, in contrast with a frame such as a single-layer carbon nanotube and a nanohorn structure in which graphite layer type hexagonal network structure walls are joined together within a layer plane to compose such a structure constituted with curved plane having a given curvature as a whole. More specifically, as illustrated in FIG. 1, it is corresponding to such a structure formed by the process wherein, to a first plane having a graphite layer type hexagonal network structure, another plane of graphite-layer-like plane gets closer from an off-plane direction so that dangling bonds of carbon atoms present in the plane ends act on the carbon atoms located within the plane of the other graphite-layer-like plane, whereby new carbon-carbon bonding is formed between those two carbon atoms to convert it into an integrated three-dimensional structure. As shown in FIG. 1, as the connections through formation of carbon-carbon bonding between these are aligned adjacently, the sites for cross-linking come in a continued cross-line.

The in-plane carbon atom to which a new carbon-carbon bond has been formed in an off-plane direction has now four bonds in total, that is, the newly formed bond in addition to originally formed bonds between three adjacent carbon atoms in the same plane. Finally, joint between two graphite layers is completed to convert them into such a shape that three graphite layer planes with different planar orientation are joined together via a carbon atom having a sp³ type hybrid orbital at the sites of the cross-line. Although it is very often that the sites of the cross-line are at least partially aligned in a line, the layer plane itself of the graphite layers forming the cross-line may, as a whole, optionally exhibit a shape being curved with a small curvature rather than planar form, and thus the sites of the cross-lines may come in a curve as a whole.

As described above, in the three-dimensional structure produced through the process for forming a connection between two graphite layers, a straight crease is formed at the sites for the cross-line to devide one graphite layer into two graphite-layer-like planes. Furthermore, a graphite layer initially involved in forming a bond from an off-planar direction is set up as a graphite layer plane not parallel to at least the adjacent graphite-layer-like plane after completing the bond forming, as shown in FIG. 1, and thereby such a structure in which the sites for the contact forms a straight crease is built up.

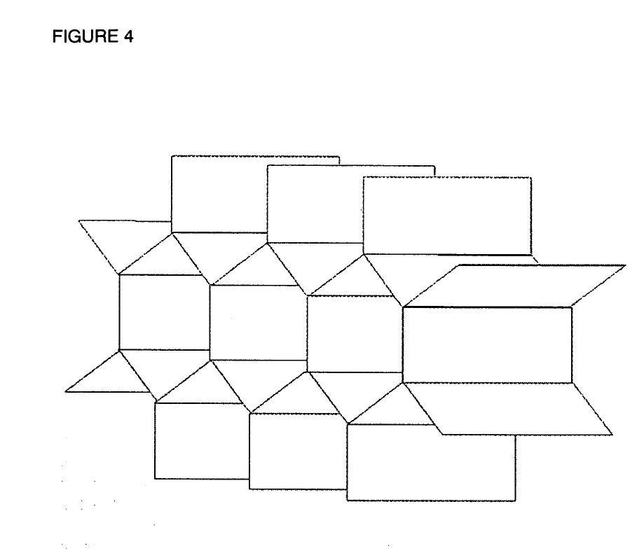

Furthermore, it is possible to form a composite three-dimensional structure where a plurality of said three-dimensional structures having the above straight crease are mutually joined. For example, as shown in FIG. 4, there may be formed a honeycomb structure which includes the three-dimensional structures having a straight crease as its ridgelines. In the composite three-dimensional structure as shown in FIG. 4, the ridgelines for each inner cell thereof are formed in such a shape that three graphite-layer-like planes are intersected to join with each other on a straight cross-line, while the outer ridgelines for the outermost cells have such a shape that two graphite-layer-like planes are mutually cross-linked to produce a straight crease. Thus, there is formed a composite three-dimensional structure having at least two different types of ridgeline shapes.

For example, in the composite three-dimensional structure shown in FIG. 4, when applying an external compressing or stretching force in the direction along to the ridgeline of its honeycomb structure, the graphite layers employed as a wall for the honeycomb structure show higher resistance to compression or stretching stress in an in-plane direction, and significantly higher mechanical strength in this direction owing to stress-decentralizing effect of the honeycomb structure itself. On the other hand, to lateral deformation distorting a cell of the above honeycomb structure, a nanosize graphite layer can allow slight flexion and can, as a whole, decentralize deformation to exhibit flexibility to a certain degree. However, for crushing the whole honeycomb structure, it is necessary either to crack a graphite layer itself to pieces that composes a wall of each cell or to break the connections via a carbon atom having a sp³ type hybrid orbital which form a ridgeline of the honeycomb structure. Thus the structure exhibits resistance to a significant external stress load. Therefore, the property of the structure such that it can flexibly respond to deformation in an in-plane direction, that is, it can be elastically deformed, while it exhibit significant robustness to an external force in a direction perpendicular to the plane, particularly a compressing force, is suitable for forming a reinforcing material that is appropriate to a coating material.

The above-mentioned mechanical strength is originated from such a feature that as in the carbonaceous three-dimensional structure according to the present invention, a plurality of graphite-layer-like planes are arranged so as to intersect or be in contact with each other on one cross-line and are joined together by formation of carbon-carbon bonds therebetween, a stress for compressing or stretching strain that is impressed along to the direction of the cross-line can be dispersed in the plurality of graphite-layer-like planes being cross-linked on the cross-line, and flexure within each graphite layer plane is suppressed, so that the structure can exhibit higher resistance as a whole. Herein, although a cell structure similar to a honeycomb structure is a more preferable form, at least, a three-dimensional structure containing at least one configuration where three or more graphite-layer-like layer planes are arranged so as to mutually intersect or be in contact with each other on the same cross-line, or alternatively, a three-dimensional structure having a configuration where at least two graphite-layer-like layer planes are non-parallel graphite layer plane so that the sites for the contact thereof form a straight crease may be, in general, a carbonaceous three-dimensional structure exhibiting much higher mechanical strength per a unit weight than that of the structure where the same number of graphite layers are simply stacked up in parallel.

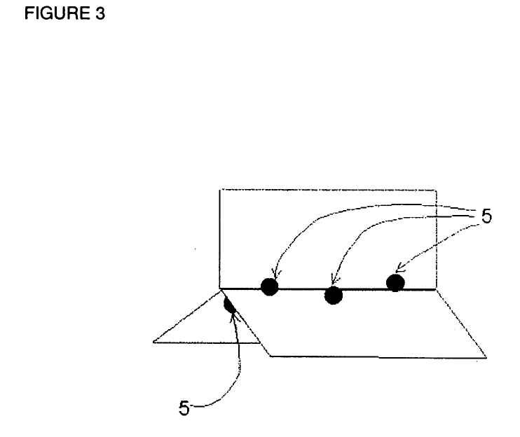

In the three-dimensional structure of carbonaceous material according to the present invention, when such a configuration where a plurality of graphite layers intersect or are in contact with each other is set up, a cross angle between two graphite layer planes comes, for example, to 120° for that shown in FIG. 1, and thus near the cross-line for the joining portion, a plane orientation will show drastically change. In other words, near the cross-line for the joining portion, a surface π-electron state is present in the manner equivalent to a case where a graphite layer plane is curved with a large curvature. As illustrated in FIG. 3, as a local curvature in such a portion for the contact is remarkably larger than the curvature in a curved graphite layer in a nanotube or an onion structure, an effective contact area thereof is increased in a physical adsorption process of molecules/atoms. Therefore, there are formed physical adsorption sites having strong adsorbing properties in the vicinity of the cross-line of the cross-linking portion. Thus, the structure can be applied to a molecule/atom adsorbing functional material. Specifically, it can be used as an adsorbing material for fuel gas molecules such as methane or ethane. In such a case, by constructing a three-dimensional structure where the cross-linking portions are two-dimensionally gathered as shown in FIG. 4, there can be provided a molecule/atom adsorbing material having a great improvement in the number of adsorbed gas molecules per a unit weight.

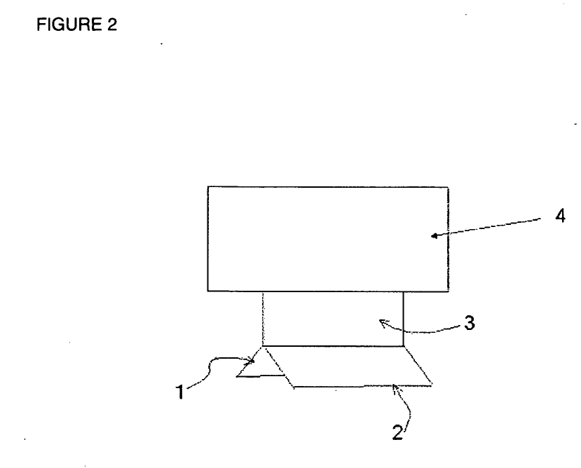

As shown in FIG. 1, connection is formed between two graphite layer planes to come in the shape where three graphite layer planes having different plane orientations are joined together in its cross-line via a carbon atom having a sp³ type hybrid orbital, and thereby a π-electron conjugation system within the graphite layer plane is interrupted in the cross-line. Specifically, on the cross-line, a chemical bond angle of a central carbon atom having a sp³ type hybrid orbital to an adjacent carbon atom is close to 109.5° of that for diamond. A plurality of such central carbons having a sp³ type hybrid orbital are continuously present on the cross-line. When a width of a graphite layer forming the cross-line as shown in FIG. 2 reaches about 100 nm, 50 or more carbon atoms are present on the cross-line, so that a fine region having a two-dimensional band structure derived from the above translational symmetry is formed therein. In such a case, a local bandgap formed in the fine region may occasionally reach up to about 1 eV.

Accordingly, in the three-dimensional structure where three graphite layer portions form carbon-carbon bonds in the cross-line as shown in FIG. 2, such a configuration that a microscopic barrier region having a different local bandgap in the cross-line is joined to a two-dimensional π-electron conjugation system type of band structure in each graphite layer portion is made up. That is to say, a current path from graphite terminal 1 to terminal 2 (or from 1 to 3, or from 2 to 3) in FIG. 2 is set up in such a form that a tunnel current passes through the microscopic barrier region in the cross-line. For example, in the case when a tunnel current is allowed to flow from terminal 1 to terminal 2 by applying a bias, the increased tunnel current can be induced by applying an electric field in a direction such that a potential is gradually reduced from the central cross-line to terminal 3. In occasion, such a three-terminal type electronic device may have properties equivalent to transistor operation. In such a case, when the local bandgap built up in the microscopic barrier region in the cross-line is about 1 eV, the increased tunnel current can be adequately caused by setting up a potential difference that is due to an externally applied electric field to about 1 eV. In practice, when the local bandgap built up in the microscopic barrier region is about 1 eV, induced change in a potential difference only by 1 eV or less may lead to 10- or more folds of change in a density of current passing through the barrier region. On the other hand, in the case when a width of the graphite layer forming the cross-line is about 100 nm, an absolute value of said current at the on-state of the operation is only in several μA. Thus, power consumption for the resultant transistor is of lower level in proportional thereto.

For example, in the case when forming a transistor utilizing the nanosize carbonaceous three-dimensional structure as illustrated in FIG. 2, if graphite layer terminals 1 and 2 are set as source and drain electrodes, respectively, the microscopic barrier region in the cross-line is influenced by the electric line of force due to gate electrode 4 via the graphite layer terminal 3, resulting in modulation of the amount of a current passing from terminal 1 to terminal 2 through the microscopic barrier region built up in the cross-line.

In the three-dimensional structure of carbonaceous material according to the present invention, in order to put the plurality of graphite-layer-like layer planes in such position that they intersect or are in contact with each other, where the portion of contact between the plurality of layer planes are constructed in such a shape that connections via carbon-carbon covalent bonds are aligned as a cross-line, nanosize graphite layer fragments are formed beforehand, and then the plurality of graphite layer fragments are impacted to each other to conduct the formation of said carbon-carbon covalent bonds. At the step of colliding the graphite layer fragments with each other, if the graphite layer fragments coming in collisions are arranged in the orientation parallel to each other, the graphite layer fragments are stacked up in the layered form in the c-axis direction, and re-growth and expansion of the graphite layer progresses within the layer plane. In final, produced therefrom is a layered graphite structure which is the most stable configuration, or alternatively in the presence of a metal catalyst, a carbon nano-material such as nanotube and fullerene [Reference A: T. Kawai, Y. Miyamoto, O. Sugino, and Y Koga, Physical Review B66, p33404 (2002)].

In the manufacturing process according to the present invention, as employed is such a condition that graphite layer fragments are mutually collided at a high speed with a collision angle between the graphite layer fragments being set at angle substantially other than 180°, such situation that from an off-plane direction in one graphite layer fragment, a plane end of another graphite layer fragment comes close with a given angle takes place. As a carbon atom at the end of the graphite layer plane has dangling bonds, a covalent bond is formed by using a π-electron exposed toward an off-plane direction from the carbon atom in the hexagonal network structure in the graphite layer fragment and an electron from said dangling bond, and whereby the formation of a carbon-carbon bond between two graphite layers can bring about the construction of three-dimensional structure as shown in FIG. 1. The three-dimensional structure thus obtained is made up in a configuration that connections via carbon-carbon covalent bonds are aligned as a cross-line and a plurality of graphite-layer-like layer planes joined mutually intersect or are in contact with each other.

Therefore, in terms of process for forming graphite layer fragments to be collided, preferably, a graphite-like material is first exposed to high-temperature and high-pressure conditions by laser evaporation. Next, gaseous carbon molecules (fragments) generated therefrom are flown along with a carrier gas and then rapidly cooled down. Due to the rapid cooing-down step, carbon molecules (fragments) and crashed-up carbon atoms are rapidly aggregated to reconstitute a graphite-like structure layer, and thereby a large number of small graphite layer fragments are produced. In addition, during the stage of rapid aggregation, there are occurred such phenomena that the graphite layer fragments produced come into collision with each other at a high speed.

In the manufacturing process according to the present invention, in the case when said phenomena that the graphite layer fragments produced are in collision at a high speed occur, by giving rise to such a situation that the graphite layer fragments are impacted to each other at a high speed with a collision angle being set up to angle substantially other than 180°, the production of the novel three-dimensional structure of the present invention is achieved.

In the manufacturing process according to the present invention, there are also produced such a byproduct as a conventional layered structure type of graphite and carbon nanotube even in small amounts, in addition to the aimed three-dimensional structure of carbonaceous material. In order to separate these byproducts from the aimed three-dimensional structure of carbonaceous material, less reactive gas molecules with a large weight such as bromine molecules (Br₂) are introduced to the carbonaceous material produced. Since the less reactive molecules such as bromine molecules are preferentially adsorbed on the aimed three-dimensional structure of carbonaceous material exhibiting higher adsorbing ability, a sample with an increased bulk specific gravity by the adsorption process can be precipitated in the solution. The precipitated substance is collected and then subjected to heat-treatment at a temperature of several hundred centigrade. The adsorbed molecules with a lower bonding affinity can be thus easily removed from the aimed three-dimensional structure of carbonaceous material. By conducting the above separation step utilizing a specific-gravity difference, only the three-dimensional structure of carbonaceous material according to the present invention finally remains.

### EXAMPLE

The present invention will be more specifically explained with reference to an example. The specific example is one of the best modes according to the present invention, but the present invention is by no means limited to the specific modes exemplified.

### Example

Under a reduced pressure, graphite evaporated by laser abrasion is converted into fine fragments having a graphite-like hexagonal network structure, which fly out at a high speed. It is well-known that when the graphite-layer-like fine fragments are re-aggregated by cooling, they can give a nano-scale structure such as fullerene and nanotube rather than multi-layered graphite which is the thermodynamically most stable structure. In particular, it is well-known that when a catalyst metal is evaporated together with graphite by laser abrasion, a nanotube structure can be more efficiently produced through re-aggregation with use of the action of the catalyst metal. When evaporated carbon fragments are aggregated without a catalyst metal, a material called “nanohone” may be synthesized [Reference B: S. Iijima, M. Yudasaka, R. Yamada, S. Bandow, K. Suenaga, F. Kokai, K. Takahashi, Chemical Physics Letter, Vol. 309 p. 165-170 (1999)].

Some of the graphite fragments generated by evaporation of graphite by laser abrasion under high-temperature and low-pressure conditions come into collision at a high speed in the orientation being not in parallel but with a given angle. The high-speed collision between graphite fragments with an angle results in the three-dimensional structure where graphite layers are mutually joined in such a shape as illustrated in FIG. 1. In that step, for achieving a high temperature, CO₂ laser irradiation is employed. By controlling a laser power and an irradiation time during CO₂ laser irradiation, the size of the fragments vaporized from a target graphite and their kinetic energy can be controlled. In the manufacturing process according to the present invention, desirably a laser power is 15 KW/cm² to 30 KW/cm², a laser pulse width is 200 ms to 700 ms, and a pulse irradiation period (frequency) is 1 s (1 Hz).

The nano-materials synthesized by said process can exist while maintaining their metastable three-dimensional structures by the help of a cooling gas in the chamber (for example, N₂, Ar and Ne). Furthermore, nano-materials having such a three-dimensional elementary structure as shown in FIG. 1 may be further aggregated to compose such a larger three-dimensional structure as illustrated in FIG. 4. FIG. 4 illustrates a part of three-dimensional elementary structures contained in an aggregated huge structure. Although not shown in FIG. 4, in the end part of the aggregated structure obtained, a graphite layer edge may remain as it is at the end, but a curved graphite layer type of linking-joint is formed such that two adjacent graphite layers at the end are connected. It may be speculated that the process for forming such a curved joint portion at the end region proceeds in accordance with a phenomenon similar to a mechanism for forming smoothly-connected graphite layer planes in a nanotube or nanohorn structure. Furthermore, between a plurality of aggregate structures which are separately produced, linking-joints may be formed during the formation of joint portion in the end region, and thereby further multiplexing may be advanced occasionally.

A graphite layer itself is chemically inert, but its layer surface has capability of adsorbing gas molecules with use of a physical adsorptive affinity. In order to increase the physical adsorptive affinity to gas molecules, it is appropriate to make the π-electrons interacting adsorbed molecules chemically active by such a way that a graphite layer plane is distorted from a flat plane to generate a curvature, and a conjugation system of π-electrons spreading in a perpendicular direction to the layer plane is interrupted by the plane distortion. In a nanotube, a curvature is generated by one graphite layer constituting thereof that is wound as a helix. In such a case, the curvature, which can be achieved thereby, is inherently limited because it depends on a radius, that is, a helix pitch of the nanotube. In contrast, the three-dimensional structure according to the present invention is a three-dimensional structure where graphite layers are branched along a central cross-line as shown in FIG. 1, and a local curvature near the central cross-line is quite superior to an averaged curvature in fullerene or nanotube. In a curved part having such a steeper angle, an effective contact area between an adsorbed molecule and a graphite layer is so large that a high adsorbing affinity can be achieved. For example, there is a good chance that it will be successfully applied to an adsorbing material for gas molecules such as methane or ethane that is required in a fuel cell. A range where the cross-line as illustrated in FIG. 1 that is applicable to the sites for absorption is formed is from several nanometers to several hundred nanometers.

In the three-dimensional structure shown in FIG. 1, when applying an external force from a direction parallel to each graphite layer, a distortion may never be induced so easily as that for one graphite layer. Such three-dimensional structure units may be two-dimensionally repeated to construct a honeycomb structure formed by single-layer graphite walls, so that as the whole three-dimensional structure having a honeycomb configuration, a material with higher mechanical strength can be obtained even though it includes a lot of openings within the cell structure. FIG. 4 illustrates an example of a structure having such a honeycomb configuration. It has a particularly higher strength along to the ridgeline direction in the honeycomb structure shown in FIG. 4. On the other hand, it exhibits flexibility to a pressure in a direction perpendicular to the direction of the honeycomb structure shown in FIG. 4, that is, in such a direction that the bending of the honeycomb structure composed of graphite layers may be occurred. However, since the graphite layer itself is resistant to a force in such a direction that the layer plane is stretched, even when the vending thereof is increased, it may not develop into the breaking up of such a three-dimensional structure as shown in FIG. 4. Thus, such a material that can flexibly respond to a given direction and can be strongly resistant to another direction, particularly to a compressing force, may be applied as a coating material.

### INDUSTRIAL APPLICABILITY

In a nanosize three-dimensional structure of carbonaceous material according to the present invention, there is provided a three-dimensional structure where, instead of stacking graphite films in a layered shape, a plurality of graphite layers are mutually in contact at an off-angle from parallel arrangement and at the site for the contact, covalent bonds between carbon atoms take shape. The three-dimensional structure can produce a material having a lighter weight and a comparable or higher strength in comparison with a conventional nano-carbonaceous material, and has advantages that it is applicable for a wide variety of uses such as composing material for a molecule/atom adsorbing structure, an electronic device and a reinforcing material, which material may fulfil its function steadily under severe conditions (for instance, under a high temperature or a strain field being initiated). In particular, it can smash a curvature limit for bending a graphite layer plane in a conventional graphite-like nano-structure of carbonaceous material, resulting in improvement in a capacity to physically adsorb, for example, molecules.

1. A carbonaceous three-dimensional structure which is a three-dimensional structure made of carbonaceous material comprising a plurality of graphite-layer-like layer planes that are composed of a hexagonal network structure made up carbon, wherein
the plurality of graphite-layer-like layer planes are arranged such that they mutually intersect or are in contact with each other; and
at the sites for the contact between the plurality of layer planes, there are aligned connections via carbon-carbon covalent bonds in the shape of a cross-line.

2. The structure as claimed in claim 1, wherein the cross-line formed at the sites for the contact between the plurality of layer planes where there are aligned connections via carbon-carbon covalent bonds constructs a straight or curved line.

3. The structure as claimed in claim 1, wherein as the sites for the contact between the plurality of layer planes where there are aligned connections via carbon-carbon covalent bonds, there is at least one structure where three or more surfaces of the graphite-layer-like layer planes are arranged so as to mutually intersect or are in contact with each other on the same cross-line.

4. A carbonaceous three-dimensional structure which is a three-dimensional structure made of carbonaceous material comprising a plurality of graphite-layer-like layer planes that are composed of a hexagonal network structure made up of carbon, wherein
the at least two graphite-layer-like layer planes are non-parallel graphite layer planes and have such a structure that the site for the contact therebetween forms a straight crease.

5. The structure as claimed in claim 4, wherein among the plurality of graphite-layer-like layer planes including the at least two graphite-layer-like layer planes of which the site for the contact forms a straight crease, the at least two graphite-layer-like layer planes forming the straight crease and at least one additional graphite-layer-like layer plane have such a configuration as to mutually cross or be in contact with each other on the same cross-line.

6. A carbonaceous three-dimensional structure made of carbonaceous material comprising a plurality of graphite-layer-like layer planes that are composed of a hexagonal network structure made up of carbon, wherein
the structure comprises at least a frame composed of some of or all of the three-dimensional structures as claimed in claim 1 concurring in compositive manner.

7. A method of using the carbonaceous three-dimensional structure as claimed in claim 1, wherein
the carbonaceous three-dimensional structure is used to form a molecule/atom adsorbing material.

8. A method of using the carbonaceous three-dimensional structure as claimed in claim 1, wherein
the carbonaceous three-dimensional structure is used to form an electronic device having at least three terminals.

9. The method for using a carbonaceous three-dimensional structure according to claim 8, wherein said electronic device having at least three terminals is a transistor.

10. A method for using the carbonaceous three-dimensional structure as claimed in claim 1, wherein
the carbonaceous three-dimensional structure is used to form a reinforcing material.

11. A process for constructing a carbonaceous three-dimensional structure made of carbonaceous material comprising a plurality of graphite-layer-like layer planes that are composed of a hexagonal network structure made up of carbon, wherein
said three-dimensional structure is the carbonaceous three-dimensional structure as claimed in claim 1; and
the process comprises the steps of:
producing graphite-layer-like fragments having a hexagonal network structure made of carbon; and
forcing the graphite-layer-like fragments produced thereby into coming into collision with each other.

12. The process as claimed in claim 11, wherein
in the step of forcing the graphite-layer-like fragments,
at least two fragments are impacted to each other in an arrangement that the fragments mutually cross or are in contact with each other at an inter-plane angle between the graphite-layer-like fragments to be in collision showing substantially other than 180°.

13. A carbonaceous three-dimensional structure which is a three-dimensional structure made of carbonaceous material comprising a plurality of graphite-layer-like layer planes that are composed of a hexagonal network structure made up of carbon, wherein
the structure comprises at least a frame composed of some of or all of the three-dimensional structures as claimed in claim 4 concurring in compositive manner.

14. A method of using the carbonaceous three-dimensional structure as claimed in claim 4, wherein
the carbonaceous three-dimensional structure is used to form a molecule/atom adsorbing material.

15. A method of using the carbonaceous three-dimensional structure as claimed in claim 4, wherein
the carbonaceous three-dimensional structure is used to form an electronic device having at least three terminals.

16. The method for using a carbonaceous three-dimensional structure according to claim 15, wherein said electronic device having at least three terminals is a transistor.

17. A method for using the carbonaceous three-dimensional structure as claimed in claim 4, wherein
the carbonaceous three-dimensional structure is used to form a reinforcing material.

18. A process for constructing a carbonaceous three-dimensional structure made of carbonaceous material comprising a plurality of graphite-layer-like layer planes that are composed of a hexagonal network structure made up of carbon, wherein
said three-dimensional structure is the carbonaceous three-dimensional structure as claimed in claim 4; and
the process comprises the steps of:
producing graphite-layer-like fragments having a hexagonal network structure made of carbon; and
forcing the graphite-layer-like fragments produced thereby into coming into collision with each other.

19. The process as claimed in claim 18, wherein
in the step of forcing the graphite-layer-like fragments,
at least two fragments are impacted to each other in an arrangement that the fragments mutually cross or are in contact with each other at an inter-plane angle between the graphite-layer-like fragments to be in collision showing substantially other than 180°.

20. A method of using the carbonaceous three-dimensional structure as claimed in claim 6, wherein
the carbonaceous three-dimensional structure is used to form a molecule/atom adsorbing material.

21. A method of using the carbonaceous three-dimensional structure as claimed in claim 6, wherein
the carbonaceous three-dimensional structure is used to form an electronic device having at least three terminals.

22. The method for using a carbonaceous three-dimensional structure according to claim 21, wherein said electronic device having at least three terminals is a transistor.

23. A method for using the carbonaceous three-dimensional structure as claimed in claim 6, wherein
the carbonaceous three-dimensional structure is used to form a reinforcing material.

24. A process for constructing a carbonaceous three-dimensional structure made of carbonaceous material comprising a plurality of graphite-layer-like layer planes that are composed of a hexagonal network structure made up of carbon, wherein
said three-dimensional structure is the carbonaceous three-dimensional structure as claimed in claim 6; and
the process comprises the steps of:
producing graphite-layer-like fragments having a hexagonal network structure made of carbon; and
forcing the graphite-layer-like fragments produced thereby into coming into collision with each other.

25. The process as claimed in claim 24, wherein
in the step of forcing the graphite-layer-like fragments,
at least two fragments are impacted to each other in an arrangement that the fragments mutually cross or are in contact with each other at an inter-plane angle between the graphite-layer-like fragments to be in collision showing substantially other than 180°.
